(19) United States
(12) Patent Application Publication
(10) Pub. No.: US 2025/0175576 A1
(43) Pub. Date: May 29, 2025

(54) INFORMATION PROVIDING METHOD, INFORMATION DISPLAY METHOD, AND COMPUTER-READABLE MEDIUM

(71) Applicant: Panasonic Automotive Systems Co., Ltd., Kanagawa (JP)

(72) Inventors: Makoto HINATA, Kanagawa Ken (JP); Fumio KOSUGE, Kanagawa Ken (JP); Shinya AIZAWA, Kanagawa Ken (JP)

(73) Assignee: Panasonic Automotive Systems Co., Ltd., Kanagawa (JP)

(21) Appl. No.: 19/036,562

(22) Filed: Jan. 24, 2025

Related U.S. Application Data
(63) Continuation of application No. PCT/JP2023/021934, filed on Jun. 13, 2023.

(30) Foreign Application Priority Data
Oct. 19, 2022 (JP) 2022-167559

(51) Int. Cl. H04N 5/775; B60R 1/22

(52) U.S. Cl. CPC H04N 5/775; B60R 1/22; B60R 2300/806

(57) ABSTRACT

An information providing method is in an image management system that communicates with an electronic device and a display terminal of a user, and manages vehicle image information captured by an imaging unit mounted on a vehicle to image surroundings of the vehicle, the electronic device being mounted on the vehicle and recording the vehicle image information. The information providing method includes: acquiring the vehicle image information from the electronic device; and transmitting power-off time image information to the display terminal to cause the display terminal to display the power-off time image information when acquiring, from the display terminal, browsing request information representing a browsing request for the power-off time image information, the power-off time image information being the vehicle image information from when power from an accessory power supply of the vehicle to the electronic device is turned off up to a predetermined time before.

### CROSS-REFERENCE TO RELATED APPLICATIONS

This application is a continuation of International Application No. PCT/JP2023/021934, filed on Jun. 13, 2023 which claims the benefit of priority of the prior Japanese Patent Application No. 2022-167559, filed on Oct. 19, 2022, the entire contents of which are incorporated herein by reference.

### FIELD

The present disclosure relates to an information providing method, an information display method, and a computer-readable medium.

### BACKGROUND

A system for providing information concerning a parking position of a vehicle is disclosed. For example, there is disclosed a system that controls start of imaging by an in-vehicle camera and a start of storage of a captured image when it is detected that a vehicle has entered a predetermined facility and controls an end of the storage of the captured image and transmission of the captured image to a mobile terminal when a parking operation of the vehicle has been detected.

A related technique is described in JP 2007-65902 A.

However, in the related art, it is necessary to provide anew an imaging control unit that controls, for example, a start of storage of a captured image according to various parking operations of the vehicle and a facility entrance detection unit that detects entrance of the vehicle into a facility, and it is difficult to easily provide information concerning a parking position with a simple configuration.

An object of the present disclosure is to provide an information providing method, an information display method, and a computer-readable medium that can easily provide information concerning a parking position with a simple configuration.

### SUMMARY

An information providing method according to the present disclosure is an information providing method in an image management system that communicates with an electronic device and a display terminal of a user, and manages vehicle image information captured by an imaging unit mounted on a vehicle to image surroundings of the vehicle, the electronic device being mounted on the vehicle and recording the vehicle image information, the information providing method including: acquiring the vehicle image information from the electronic device; and transmitting power-off time image information to the display terminal to cause the display terminal to display the power-off time image information when acquiring, from the display terminal, browsing request information representing a browsing request for the power-off time image information, the power-off time image information being the vehicle image information from when power from an accessory power supply of the vehicle to the electronic device is turned off up to a predetermined time before.

### BRIEF DESCRIPTION OF THE DRAWINGS

FIG. 1 is a schematic diagram of an example of an information providing system;

FIG. 2 is a functional block diagram of an example of the information providing system;

FIG. 3A is a schematic diagram illustrating an example of a data configuration of user management information;

FIG. 3B is an explanatory diagram of an example of a storage area of a storage unit;

FIG. 3C is a schematic diagram illustrating an example of a data configuration of image management information;

FIG. 4A is a schematic diagram of an example of a list displayed on a display terminal;

FIG. 4B is a schematic diagram of an example of a list displayed on the display terminal;

FIG. 4C is a schematic diagram of an example of a display screen of power-off time image information;

FIG. 5 is a sequence diagram illustrating an example of a flow of information processing executed by the information providing system;

FIG. 6 is a flowchart illustrating an example of a flow of information processing executed in an image management system;

FIG. 7 is a sequence diagram illustrating an example of a flow of information processing executed by the information providing system;

FIG. 8 is a flowchart illustrating an example of a flow of information processing executed in the image management system; and

FIG. 9 is a block diagram illustrating a hardware configuration example.

### DETAILED DESCRIPTION

Embodiments of an Information providing method, an information display method, and an information providing program according to the present disclosure are explained below with reference to the accompanying drawings.

### First Embodiment

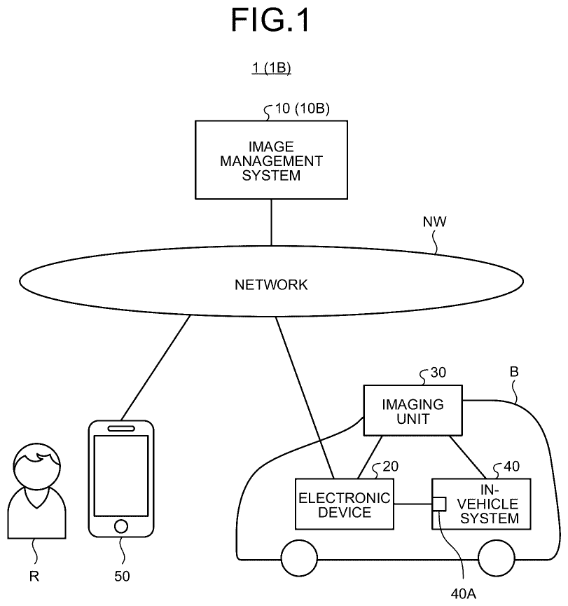

FIG. 1 is a schematic diagram of an example of an information providing system 1 in the present embodiment. The information providing system 1 is a system that provides information concerning a parking position of a vehicle B.

The information providing system 1 includes an image management system 10, an electronic device 20, and a display terminal 50.

The image management system 10, the display terminal 50, and the electronic device 20 are communicably connected via a network NW or the like.

The image management system 10 communicates with the electronic device 20 and the display terminal 50 and manages vehicle image information and the like acquired from the electronic device 20. Details of the vehicle image information is explained below.

The display terminal 50 is an information processing device managed by a user R. In the present embodiment, a mode in which the display terminal 50 is a portable information terminal such as a smartphone and a tablet terminal is explained as an example.

In the present embodiment, the user R who manages the display terminal 50 is a user of the vehicle B. The user of the vehicle B is, for example, a driver of the vehicle B, an occupant other than the driver of the vehicle B, an owner of the vehicle B, or the like. In the present embodiment, a case in which the user R is a driver of the vehicle B is explained as an example.

The electronic device 20 is mounted on the vehicle B. At least the electronic device 20, an in-vehicle system 40, and an imaging unit 30 are mounted on the vehicle B. The electronic device 20, the imaging unit 30, and the in-vehicle system 40 are communicably connected.

The electronic device 20 stores vehicle image information captured by the imaging unit 30 and transmits the vehicle image information to the image management system 10. The electronic device 20 is a communication type drive recorder having a communication function.

The imaging unit 30 is an in-vehicle camera mounted on the vehicle B. In the imaging unit 30, an imaging angle of view, an imaging direction, an imaging magnification, and the like are adjusted in advance so that the surroundings of the vehicle B can be photographed. The imaging unit 30 images the surroundings of the vehicle B to obtain vehicle image information. The vehicle image information is captured image data captured by the imaging unit 30. That is, the vehicle image information is captured image data of the surroundings of the vehicle B.

The in-vehicle system 40 is various systems provided in the vehicle B. The in-vehicle system 40 is executed by, for example, one or a plurality of ECUs (Electronic Control Units) mounted on the vehicle B. In the present embodiment, the in-vehicle system 40 includes an accessory power supply 40A.

The accessory power supply 40A is a power supply for operating electrical components that do not directly affect traveling of the vehicle B. The accessory power supply 40A is switched from an on state to an off state by the user R or the like, who gets on the vehicle B, parking the vehicle B at a desired part and operating an ignition switch provided in the vehicle B. When the accessory power supply 40A is switched to the off state, power supply from the accessory power supply 40A to the electronic device 20 and the electrical components of the vehicle B is cut off and a state of power-off is reached. In the present embodiment, the power-off means a state in which the accessory power supply 40A is switched to the off state and power supply from the accessory power supply 40A to the electronic device 20 is cut off.

The accessory power supply 40A is switched from the off state to the on state by the user R or the like, who is riding the vehicle B, operating an ignition switch when switching an engine of the vehicle B to the on state to cause the vehicle B to travel. When the accessory power supply 40A is switched to the on state, the power supply from the accessory power supply 40A to the electronic device 20 and the electrical components of the vehicle B is started and a state of power-on is reached.

The electronic device 20 operates with electric power supplied from the accessory power supply 40A and electric power supplied from a built-in battery. The electronic device 20 operates with the electric power supplied from the accessory power supply 40A at a power-on time when the electric power is supplied from the accessory power supply 40A to the electronic device 20. The electronic device 20 operates with the electric power supplied from the built-in battery when the power from the accessory power supply 40A to the electronic device 20 is turned off. The built-in battery may be mounted on any of the electronic device 20, the in-vehicle system 40, and the outside of the in-vehicle system 40 in the vehicle B.

The imaging unit 30 operates with the electric power supplied from the accessory power supply 40A and the electric power supplied from the built-in battery. It is assumed that the imaging unit 30 continuously performs imaging at least in a power-on period in which the electric power is supplied from the accessory power supply 40A to the imaging unit 30. The imaging unit 30 may continuously perform imaging also in a period in which the power supply from the accessory power supply 40A to the imaging unit 30 is cut off and in which the electric power is supplied from the internal battery or the like.

Subsequently, the image management system 10, the display terminal 50, and the electronic device 20 are explained in detail.

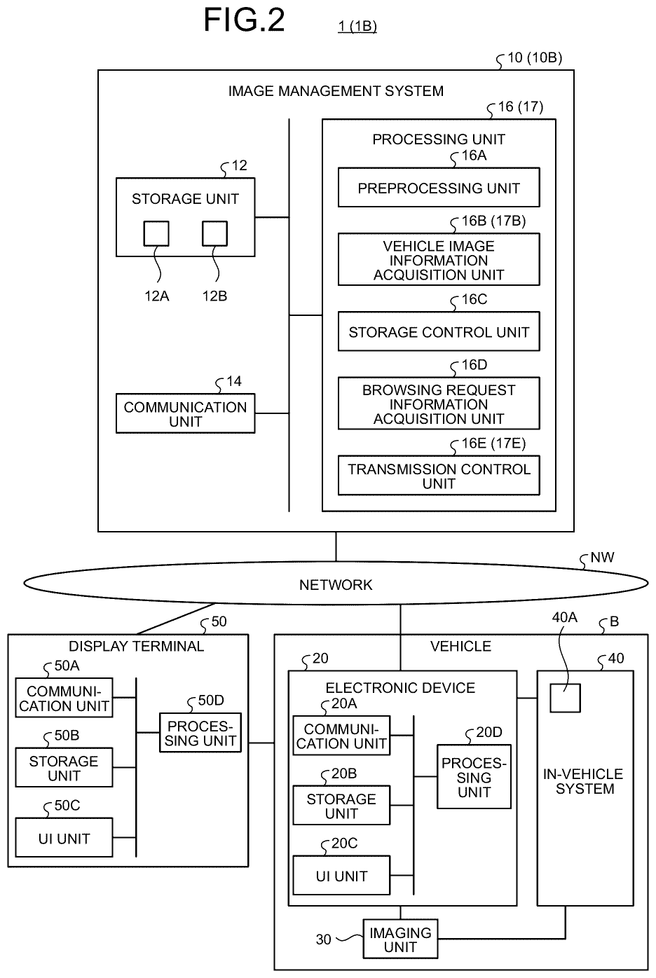

FIG. 2 is a functional block diagram of an example of the information providing system 1.

First, the electronic device 20 is explained. As explained above, the electronic device 20 is the communication type drive recorder having the communication function. For example, the electronic device 20 includes a communication unit 20A, a storage unit 20B, a UI (user interface) unit 20C, and a processing unit 20D.

The communication unit 20A communicates with other information processing devices. In the present embodiment, the communication unit 20A communicates with the image management system 10, the imaging unit 30, and the in-vehicle system 40. The storage unit 20B stores various kinds of information. In the present embodiment, the storage unit 20B stores vehicle image information captured by the imaging unit 30. The UI unit 20C includes a display function for displaying various kinds of information and an input function for receiving operation input by the user R. The UI unit 20C may function as a part of a panel provided in the vehicle B and operated by an occupant of the vehicle B.

The processing unit 20D executes various kinds of information processing in the electronic device 20.

In the present embodiment, the processing unit 20D stores the vehicle image information acquired from the imaging unit 30 in the storage unit 20B. In addition, every time an event having a predetermined attribute occurs, the processing unit 20D stores a date and time of the occurrence of the event and the attribute of the occurred event in the storage unit 20B in association with the vehicle image information. Examples of the event having the predetermined attribute include, but are not limited to, impact detection. The impact detection indicates that acceleration equal to or greater than a predetermined value is detected in the vehicle B. Every time the event having the predetermined attribute occurs, the processing unit 20D transmits the date and time of the occurrence of the event, the attribute of the event, and vehicle image information at the time of the occurrence of the event to the image management system 10 via the communication unit 20A.

Further, in the present embodiment, the processing unit 20D of the electronic device 20 stores, in the storage unit 20B, at the time when power from the accessory power supply 40A to the electronic device 20 is turned off, an attribute representing the power-off, a date and time of the power-off, and power-off time image information, which is vehicle image information from when the power is turned off up to a predetermined time t before, in association with each other. That is, the power-off time image information is an example of vehicle image information and is vehicle image information captured in a period from when the power is turned off up to the predetermined time t before, which is a specific period. The processing unit 20D in the present embodiment transmits, to the image management system 10 via the communication unit 20A, the date and time of the power-off, the attribute representing the power-off, and the power-off time image information, which is the vehicle image information from when the power is turned off up to the predetermined time t before.

The predetermined time t only has to be determined in advance. For example, the predetermined time t only has to be set in advance for each type of an attribute according to an operation instruction or the like of the UI unit 20C by the user R. The predetermined time t of the attribute representing the power-off is, for example, several 10 seconds but is not limited to this period.

Subsequently, a functional configuration of the display terminal 50 is explained.

The display terminal 50 includes a communication unit 50A, a storage unit 50B, a UI unit 50C, and a processing unit 50D. The communication unit 50A, the storage unit 50B, the UI unit 50C, and the processing unit 50D are communicably connected.

The communication unit 50A communicates with other information processing devices. The storage unit 50B stores various kinds of information. The UI unit 50C includes a display function for displaying various kinds of information and an input function for receiving an operation input by the user R. The display function is, for example, a display. The input function is a keyboard, a pointing device such as a mouse or a pen tablet, or the like. The UI unit 50C may be a touch panel in which a display function and an input function are integrally configured. In the present embodiment, a case in which the UI unit 50C is a touch panel is explained as an example.

The processing unit 50D of the display terminal 50 executes various kinds of information processing. In the present embodiment, the processing unit 50D executes downloading of a dedicated application, display of various images on the UI unit 50C, processing according to various kinds of instruction information such as browsing request information received by an operation instruction to the UI unit 50C by the user R, and the like. Details of the processing by the processing unit 50D are explained below.

Subsequently, a functional configuration of the image management system 10 is explained.

The image management system 10 communicates with the display terminal 50 and the electronic device 20 of the user R and manages vehicle image information.

The image management system 10 includes a storage unit 12, a communication unit 14, and a processing unit 16.

The storage unit 12, the communication unit 14, and the processing unit 16 are communicably connected. The image management system 10 may further include a UI unit.

The storage unit 12 stores various kinds of information. In the present embodiment, the storage unit 12 stores user management information 12A and image management information 12B.

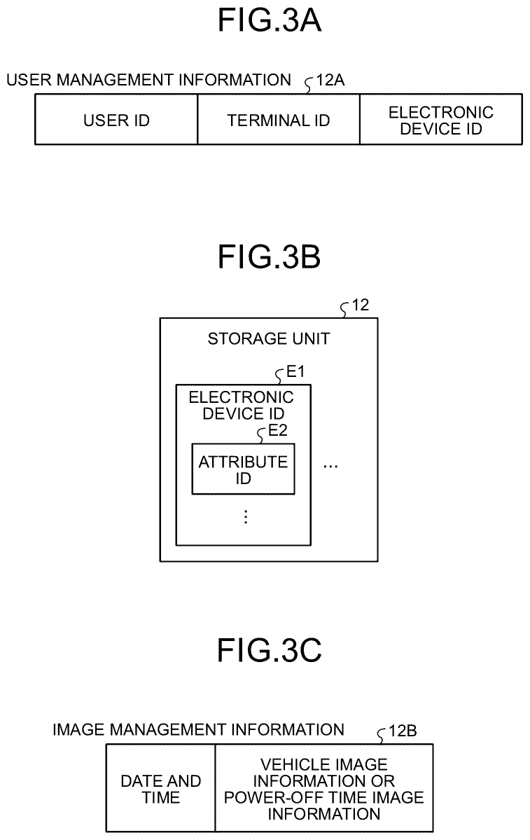

FIG. 3A is a schematic diagram illustrating an example of a data configuration of the user management information 12A. The user management information 12A is a database for managing information concerning the user R. A data format of the user management information 12A may be a table or the like and is not limited to the database. In the present embodiment, structures of a database, a table, and data used in the present embodiment are simplified and described. Actual structures of the database, the table, and the data may be more complex but portions not directly related to the present embodiment are more simplified than the actual structure and shown.

The user management information 12A is information in which a user ID, a terminal ID, and electronic device ID are associated with one another. The user ID is identification information of the user R. The terminal ID is identification information of the display terminal 50 managed by the user R. The electronic device ID is identification information of the electronic device 20 mounted on the vehicle B used by the user R.

FIG. 3B is an explanatory diagram of an example of a storage area of the storage unit 12.

In the present embodiment, the storage area of the storage unit 12 includes electronic device storage area E1 for each piece of the electronic device 20. That is, in the storage unit 12, the electronic device storage area E1 for is provided each piece of the electronic device 20, in other words, for each of users R who use the vehicle B on which the electronic device 20 is mounted. An electronic device ID of the electronic device 20 is assigned to each of a plurality of electronic device storage areas E1.

In each of the plurality of electronic device storage areas E1, an event attribute storage area E2 is provided for each of attributes. An attribute ID is assigned to each of a plurality of event attribute storage areas E2 included in the electronic device storage area E1. The attribute ID is identification information of an attribute. In the present embodiment, the attribute of the event represents impact detection, power-off, or the like. For this reason, in the present embodiment, a mode in which the attribute ID indicates either impact detection or power-off from the accessory power supply 40A is explained as an example. The power-off from the accessory power supply 40A is sometimes simply referred to as power-off and explained.

A storage capacity of each of the electronic device storage area E1 and the event attribute storage area E2 is predetermined. One electronic device storage area E1 includes a plurality of event attribute storage areas E2. For this reason, the storage capacity of the event attribute storage area E2 is preset to be less than the storage capacity of the electronic device storage area E1.

The image management information 12B is registered in the event attribute storage area E2.

FIG. 3C is a schematic diagram illustrating an example of a data configuration of the image management information 12B. The image management information 12B is information in which a date and time and vehicle image information or power-off time image information are associated with each other. For example, a scene is assumed in which the image management information 12B is registered in the event attribute storage area E2 to which a certain attribute ID is assigned in the electronic device storage area E1 to which a certain electronic device ID is assigned. In this case, in the image management information 12B, a date and time and vehicle image information or power-off time image information at a time of occurrence of an event having an attribute identified with an attribute ID of the event attribute storage area E2, where the image management information 12B is stored, acquired from the electronic device 20 identified with an electronic device ID of the electronic device storage area E1, where the image management information 12B is stored are registered in association with each other.

Referring back to FIG. 2, the explanation is continued.

Subsequently, the processing unit 16 is explained. The processing unit 16 executes various kinds of information processing in the image management system 10. The processing unit 16 includes a preprocessing unit 16A, a vehicle image information acquisition unit 16B, a storage control unit 16C, a browsing request information acquisition unit 16D, and a transmission control unit 16E.

A part or all of the preprocessing unit 16A, the vehicle image information acquisition unit 16B, the storage control unit 16C, the browsing request information acquisition unit 16D, and the transmission control unit 16E may be implemented by causing a processing device such as a CPU (Central Processing Unit) to execute a program, that is, by software, may be implemented by hardware such as an IC (Integrated Circuit), or may be implemented by using software and hardware in combination. At least one of the preprocessing unit 16A, the vehicle image information acquisition unit 16B, the storage control unit 16C, the browsing request information acquisition unit 16D, and the transmission control unit 16E may be mounted on an external information processing device communicably connected to the image management system 10 via the network NW or the like.

The preprocessing unit 16A executes preprocessing concerning management of vehicle image information. Specifically, the preprocessing unit 16A permits dedicated application download to the display terminal 50 in response to a dedicated application download request received from the display terminal 50. When the preprocessing unit 16A permits the dedicated application download, a dedicated application is downloaded to the display terminal 50.

The dedicated application is an application for executing processing such as user registration in the image management system 10, transmission of various kinds of request information such as list acquisition request information and browsing request information, and display of vehicle image information or power-off time image information in the display terminal 50. In the present embodiment, application is sometimes explained by calling it app.

When the dedicated application is downloaded to the display terminal 50, the dedicated application is installed in the display terminal 50. When the dedicated application is installed, the display terminal 50 can perform processing such as user registration in the image management system 10, transmission of various kinds of request information such as the list acquisition request information and the browsing request information, and display of the vehicle image information or the power-off time image information.

When user registration information is transmitted to the image management system 10 according to an operation instruction to the display terminal 50 by the user R, the preprocessing unit 16A of the image management system 10 receives the user registration information. The preprocessing unit 16A registers a user ID, a terminal ID, and an electronic device ID included in the received user registration information in the user management information 12A in association with one another. Note that the preprocessing unit 16A may receive the user registration information including the user ID and the terminal ID from the display terminal 50. Then, the preprocessing unit 16A may further receive the electronic device ID of the electronic device 20 and at least one of the terminal ID and the user ID from the electronic device 20. In this case, the preprocessing unit 16A only has to register the user ID, the terminal ID, and the electronic device ID received from the display terminal 50 and the electronic device 20 in the user management information 12A in association with one another.

Subsequently, the vehicle image information acquisition unit 16B is explained.

The vehicle image information acquisition unit 16B acquires vehicle image information from the electronic device 20.

As explained above, every time an event having an attribute such as impact detection occurs, the processing unit 20D of the electronic device 20 transmits a date and time of the event occurrence, the attribute of the event, and vehicle image information at the event occurrence time to the image management system 10 via the communication unit 20A. For this reason, every time the event such as impact detection occurs, the vehicle image information acquisition unit 16B acquires the date and time of the event occurrence, the attribute of the event, and the vehicle image information at the event occurrence time.

In the present embodiment, the vehicle image information acquisition unit 16B acquires power-off time image information from the electronic device 20 when the power from the accessory power supply 40A to the electronic device 20 is turned off.

Specifically, as explained above, at the time when the power from the accessory power supply 40A to the electronic device 20 is turned off, the processing unit 20D of the electronic device 20 transmits, to the image management system 10, an attribute representing the power-off, a date and time of the power-off, and power-off time image information, which is vehicle image information from when the power is turned off up to the predetermined time t before. For this reason, the vehicle image information acquisition unit 16B acquires the power-off time image information from the electronic device 20 at the time when the power from the accessory power supply 40A to the electronic device 20 is turned off. That is, in the present embodiment, the power-off time image information is acquired at the time of the power-off from the accessory power supply 40A to the electronic device 20 of the vehicle B.

As explained above, when the user R parks the vehicle B in a desired place and operates the ignition switch to an off state, the accessory power supply 40A is switched from the on state to the off state. For this reason, the power-off time image information indicates vehicle image information at the time when the vehicle B is parked. That is, the power-off time image information is vehicle image information including at least a period from the predetermined time t before the vehicle B is parked until the vehicle B is parked. Then, in the present embodiment, the vehicle image information acquisition unit 16B acquires the power-off time image information from the electronic device 20 when the vehicle B is parked in desired place of the user R.

The storage control unit 16C performs storage control for various kinds of information in the storage unit 12.

The storage control unit 16C stores the date and time of the event occurrence, the attribute of the event, and the vehicle image information at the event occurrence time acquired by the vehicle image information acquisition unit 16B in the storage unit 12 in association with one another. Specifically, the storage control unit 16C registers the vehicle image information and the date and time of the event occurrence acquired by the vehicle image information acquisition unit 16B in the image management information 12B of the event attribute storage area E2 of the attribute ID of the attribute of the acquired event in the electronic device storage area E1 of the electronic device ID of the electronic device 20 at an acquisition source of the vehicle image information. That is, every time the vehicle image information acquisition unit 16B acquires new vehicle image information, the storage control unit 16C stores the vehicle image information in the event attribute storage area E2 of the electronic device storage area E1 corresponding to the electronic device 20 at a transmission source and the attribute of the vehicle image information in the storage unit 12.

The storage control unit 16C stores the attribute representing the power-off, the date and time of the power-off, and the power-off time image information acquired by the vehicle image information acquisition unit 16B in the storage unit 12 in association with one another. Specifically, the storage control unit 16C stores the power-off time image information in the event attribute storage area E2 for the attribute ID of the power-off, which is the acquired attribute, in the electronic device storage area E1 for the electronic device ID of the electronic device 20 at the acquisition source of the power-off time image information.

As explained above, the storage capacity of each of the electronic device storage area E1 and the event attribute storage area E2 is predetermined. For this reason, when storing new vehicle image information and power-off time image information in the event attribute storage area E2, if a data capacity of at least one of the event attribute storage area E2 for a storage target and the electronic device storage area E1 including the event attribute storage area E2 exceeds the predetermined storage capacity because the storage of the information, storing may be made by performing overwriting in order from the vehicle image information having the oldest date and time. According to these kinds of processing, the storage control unit 16C can suppress data exceeding a data capacity of the predetermined storage capacity from being stored in the storage unit 12.

The browsing request information acquisition unit 16D acquires, from the display terminal 50, browsing request information representing a browsing request for the power-off time image information.

Specifically, the browsing request information acquisition unit 16D acquires the list acquisition request information from the display terminal 50. The list acquisition request information is an acquisition request for a list of image names of the vehicle image information and the power-off time image information transmitted from the electronic device 20 to the image management system 10. In the present embodiment, a case in which the date and time and the attribute of the vehicle image information and the power-off time image information are used as the image name is explained as an example. The list acquisition request information includes a terminal ID of the display terminal 50 at a transmission source of the list acquisition request information.

The browsing request information acquisition unit 16D having acquired the list acquisition request information identifies an electronic device ID corresponding to the terminal ID included in the list acquisition request information in the user management information 12A. Then, the browsing request information acquisition unit 16D reads, as a list, the date and time and the attribute of each of all the vehicle image information and the power-off time image information stored in each of the event attribute storage areas E2 included in the electronic device storage area E1 to which the identified electronic device ID is assigned. The browsing request information acquisition unit 16D transmits the read list to the display terminal 50.

The display terminal 50 displays the list received from the image management system 10 on the UI unit 50C.

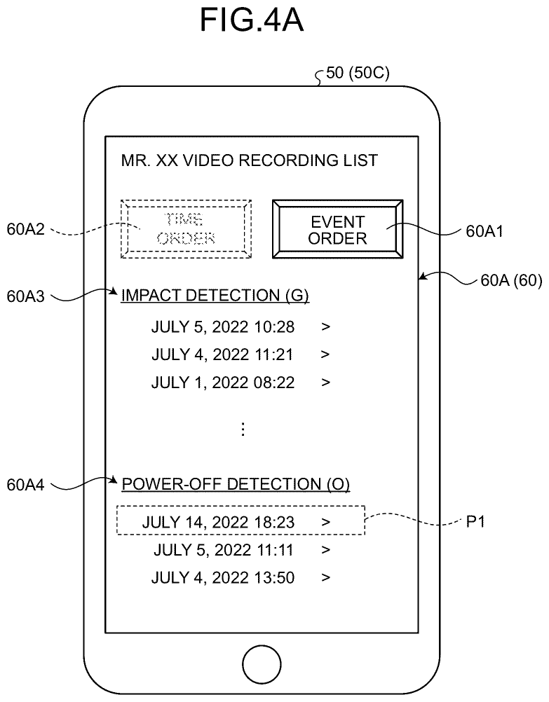

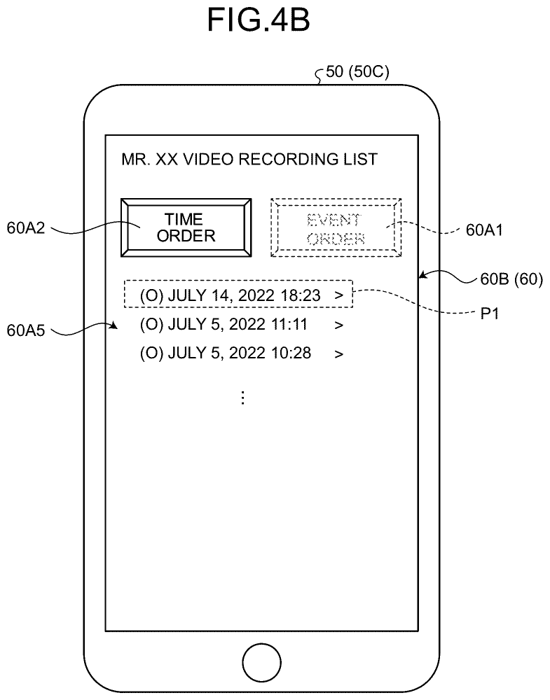

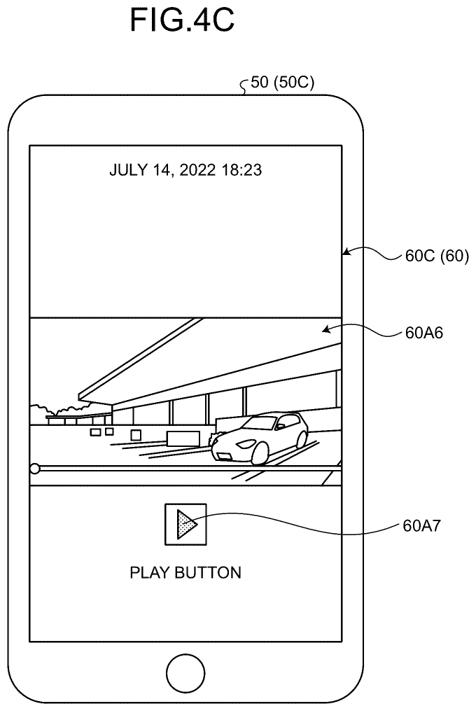

FIGS. 4A and 4B are schematic diagrams of an example of the list displayed on the UI unit 50C.

FIG. 4A illustrates, as an example, a display screen 60A displaying, for each attribute, a list of date and times of each of the vehicle image information and the power-off time image information. The display screen 60A is an example of a display screen 60 displayed on the UI unit 50C. The display screen 60A is an example of the display screen 60 displayed when a button image 60A1 for instructing to display the list for each attribute is operated. For example, as illustrated in FIG. 4A, in a display field 60A3 of “attribute detection (G)” representing an attribute of impact detection, a list of dates and times of vehicle image information having the attribute is displayed. In addition, as illustrated in FIG. 4A, in a display field 60A4 of “power-off detection (O)” representing an attribute of power-off, a list of dates and times of power-off time image information having the attribute is displayed.

FIG. 4B illustrates, as an example, a display screen 60B displaying a list of date and times of each of the vehicle image information and the power-off time image information in chronological order. The display screen 60B is an example of the display screen 60 displayed on the UI unit 50C. The display screen 60B is an example of the display screen 60 displayed when a button image 60A2 for instructing to display the list in chronological order is operated. For example, as illustrated in FIG. 4B, in a display field 60A5 of the display screen 60B, a list of “(G)” representing the attribute of the impact detection, the date and time of the vehicle image information having the attribute, “(O)” representing the attribute of the power-off, and the date and time of the power-off time image information having the attribute is displayed in chronological order.

The user R operates the UI unit 50C while visually recognizing the display screen 60 to select a display field of a desired date and time. For example, a scene is assumed in which a display field P1 of the date and time “Jul. 14, 2022 18:23” of the vehicle image information having the attribute of the power-off is selected.

Then, the processing unit 20D of the display terminal 50 transmits browsing request information including the selected date and time, the attribute, and the terminal ID of the display terminal 50 to the image management system 10 via the communication unit 20A. When the attribute represents the power-off, the browsing request information is information representing a browsing request for the power-off time image information. Here, the explanation is continued assuming a scene in which the display terminal 50 transmits the browsing request information for the power-off time image information to the image management system 10.

Referring back to FIG. 2, the explanation is continued. The browsing request information acquisition unit 16D acquires, from the display terminal 50, browsing request information representing a browsing request for the power-off time image information.

When acquiring the browsing request information representing the browsing request for the power-off time image information from the display terminal 50, the transmission control unit 16E transmits the power-off time image information to the display terminal 50 in order to cause the display terminal 50 to display the power-off time image information. Specifically, the transmission control unit 16E transmits the power-off time image information specified in the browsing request information from the display terminal 50 to the display terminal 50 in order to cause the display terminal 50 to display the power-off time image information.

For example, a scene is assumed in which the browsing request information acquisition unit 16D acquires browsing request information including a date and time “Jul. 14, 2022 18:23” of the vehicle image information having the attribute of the power-off, the attribute of the power-off, and the terminal ID of the display terminal 50. In this case, the transmission control unit 16E identifies, from the user management information 12A, an electronic device ID corresponding to the terminal ID included in the acquired browsing request information. Then, the transmission control unit 16E identifies power-off time image information associated with the date and time included in the browsing request information in the event attribute storage area E2 to which the attribute ID of the attribute “power-off” included in the browsing request information is assigned included in the electronic device storage area E1 to which the identified electronic device ID is assigned. Then, the transmission control unit 16E transmits the identified power-off time image information and the date and time of the power-off time image information to the display terminal 50 identified with the terminal ID included in the browsing request information.

The processing unit 50D of the display terminal 50 having received the power-off time image information displays the received power-off time image information on the UI unit 50C.

FIG. 4C is a schematic diagram of an example of a display screen 60C for the power-off time image information. The display screen 60C is an example of the display screen 60. FIG. 4C illustrates, as an example, a state in which the power-off time image information of the date and time “Jul. 14, 2022 18:23” selected from the list by the user R is displayed in a display field 60A6.

The display screen 60C includes a play button 60A7. When the user R operates the play button 60A7, the processing unit 50D plays back the power-off time image information displayed in the display field 60A6.

As explained above, the power-off time image information is vehicle image information from when the power from the accessory power supply 40A to the electronic device 20 is turned off up to the predetermined time t before. That is, the power-off time image information is vehicle image information including at least a period from the predetermined time t before the vehicle B is parked until the vehicle B is parked. For this reason, the user R can easily check information concerning a parking position of the vehicle B by visually recognizing the power-off time image information displayed on the display screen 60.

Referring back to FIG. 2, the explanation is continued. After the transmission control unit 16E transmits the power-off time image information in order to cause the display terminal 50 to display the power-off time image information, new vehicle image information is sometimes acquired from the electronic device 20 at an acquisition source of the power-off time image information. That is, it is assumed that the ignition switch of the vehicle B in a parked state is operated by the user R or the like riding on the vehicle B and the engine is turned on. In this case, the accessory power supply 40A is switched from the off state to the on state, power supply from the accessory power supply 40A to the electronic device 20 is started, and the state of power on is reached. Then, the transmission of the vehicle image information at every event occurrence from the electronic device 20 to the image management system 10 is resumed.

When the vehicle image information acquisition unit 16B acquires vehicle image information anew, the storage control unit 16C deletes power-off time image information registered in the event attribute storage area E2 to which the attribute ID of the attribute “power off” is assigned in the electronic device storage area E1 to which the electronic device ID of the electronic device 20 at a transmission source of the acquired vehicle image information is assigned in the storage unit 12. The storage control unit 16C may delete all pieces of power-off time image information registered in the event attribute storage area E2 or may delete a predetermined number of pieces of power-off time image information in order from the oldest date and time.

Since the storage control unit 16C executes deletion processing for the power-off time image information, a data amount in the storage unit 12 can be suppressed.

Subsequently, an example of a flow of information processing executed by the information providing system 1 in the present embodiment is explained.

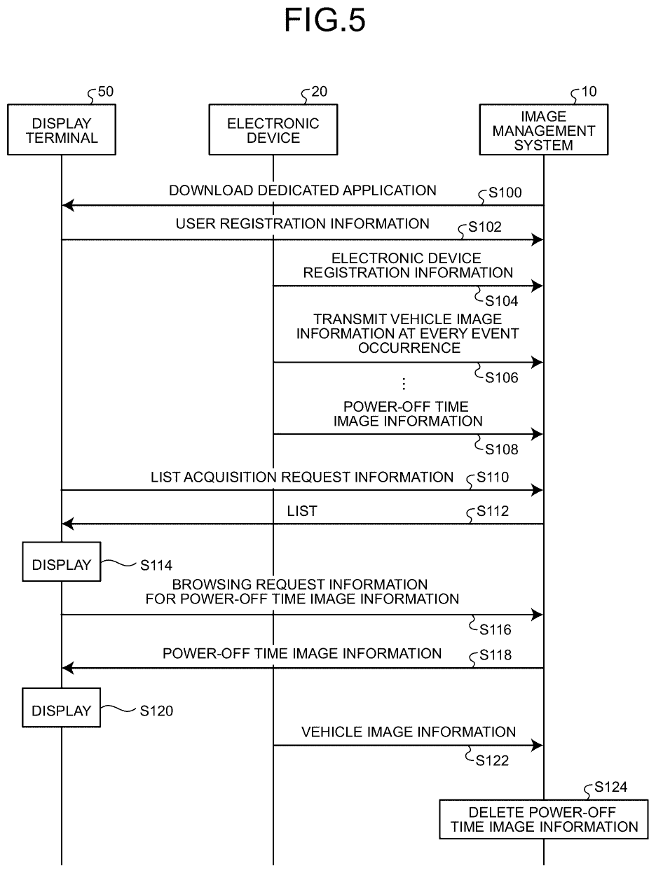

FIG. 5 is a sequence diagram illustrating the example of the flow of the information processing executed by the information providing system 1 in the present embodiment.

The processing unit 50D of the display terminal 50 transmits a dedicated application download request to the image management system 10 to download a dedicated application from the image management system 10 (step S100). The processing unit 50D of the display terminal 50 installs the downloaded dedicated application.

When user registration information is transmitted to the image management system 10 according to an operation instruction to the display terminal 50 by the user R (step S102), the preprocessing unit 16A of the image management system 10 receives the user registration information. The preprocessing unit 16A of the image management system 10 receives, from the electronic device 20, electronic device registration information including the electronic device ID of the electronic device 20 and at least one of a terminal ID and a user ID (step S104). The preprocessing unit 16A registers the user ID, the terminal ID, and the electronic device ID received from the display terminal 50 and the electronic device 20 in user management information 12A in association with one another.

Every time an event having an attribute such as impact detection occurs, the processing unit 20D of the electronic device 20 transmits a date and time of the event occurrence, the attribute of the event, and vehicle image information at the time of the event occurrence to the image management system 10 (step S106). The storage control unit 16C of the image management system 10 stores the date and time of the event occurrence, the attribute of the event, and the vehicle image information at the time of the event occurrence acquired in step S106 in the storage unit 12 in association with one another. Every time the vehicle image information acquisition unit 16B acquires new vehicle image information, the storage control unit 16C stores the vehicle image information in the event attribute storage area E2 of the electronic device storage area E1 corresponding to the electronic device 20 at a transmission source and the attribute of the vehicle image information in the storage unit 12.

When the vehicle B on which the electronic device 20 is mounted is parked and the electronic device 20 changes to a power-off state in which power supply from the accessory power supply 40A to the electronic device 20 is cut off, the electronic device 20 transmits an attribute representing power-off, a date and time of the power-off, and power-off time image information, which is vehicle image information from when the power is turned off up to the predetermined time t before, to the image management system 10 (step S108). The storage control unit 16C of the image management system 10 stores the attribute representing the power-off, the date and time of power-off, and the power-off time image information acquired in step S108 in the storage unit 12 in association with one another. The storage control unit 16C registers the power-off time image information in the image management information 12B in the event attribute storage area E2 having the attribute ID of the power-off, which is the acquired attribute, in the electronic device storage area E1 having the electronic device ID of the electronic device 20 at an acquisition source of the power-off time image information.

After parking the vehicle B, the user R such as a driver of the vehicle B operates the UI unit 50C of the display terminal 50 at a desired timing to input a list acquisition request. The processing unit 50D of the display terminal 50 having received the list acquisition request transmits list acquisition request information to the image management system 10 (step S110).

The browsing request information acquisition unit 16D of the image management system 10 having acquired the list acquisition request information identifies an electronic device ID corresponding to a terminal ID included in the list acquisition request information acquired in step S110 in the user management information 12A. Then, the browsing request information acquisition unit 16D reads, as a list, the date and time and the attribute of each of all the vehicle image information and the power-off time image information stored in each of the event attribute storage areas E2 included in the electronic device storage area E1 to which the identified electronic device ID is assigned. The browsing request information acquisition unit 16D of the image management system 10 transmits the read list to the display terminal 50 (step S112).

The display terminal 50 displays the list received from the image management system 10 on the UI unit 50C (step S114). According to the processing in step S110 to step S114, for example, the display screen 60 illustrated in FIG. 4A or FIG. 4B is displayed on the UI unit 50C of the display terminal 50.

The user R operates the UI unit 50C while visually recognizing the display screen 60 to select a display field of a desired date and time. The processing unit 20D of the display terminal 50 transmits browsing request information including the selected date and time, the attribute, and the terminal ID of the display terminal 50 to the image management system 10 (step S116). When the attribute represents the power-off, the browsing request information is information representing a browsing request for the power-off time image information. Here, the explanation is continued assuming a scene in which the display terminal 50 transmits the browsing request information for the power-off time image information to the image management system 10.

The browsing request information acquisition unit 16D of the image management system 10 acquires the browsing request information representing the browsing request for the power-off time image information from the display terminal 50 (step S116). The transmission control unit 16E of the image management system 10 identifies, from the storage unit 12, power-off time image information corresponding to the electronic device ID corresponding to the terminal ID, the attribute of the power-off, and the date and time included in the browsing request information acquired in step S116. Then, the transmission control unit 16E of the image management system 10 transmits the identified power-off time image information and the date and time of the power-off time image information to the display terminal 50 at a transmission source of the browsing request information in step S116 (step S118).

The processing unit 50D of the display terminal 50 having received the power-off time image information displays the received power-off time image information on the UI unit 50C (step S120). According to the processing in step S116 to step S120, the power-off time image information acquired in step S118 is displayed on the UI unit 50C of the display terminal 50 (see FIG. 4C).

When the accessory power supply 40A is switched from the off state to the on state and power supply from the accessory power supply 40A to the electronic device 20 is started, the transmission of the vehicle image information at every event occurrence from the electronic device 20 to the image management system 10 is resumed (step S122).

When the vehicle image information acquisition unit 16B of the image management system 10 acquires the vehicle image information, the storage control unit 16C of the image management system 10 deletes the power-off time image information registered in the event attribute storage area E2 to which the attribute ID of the attribute “power off” is assigned in the electronic device storage area E1 to which the electronic device ID of the electronic device 20 at a transmission source of the acquired vehicle image information is assigned in the storage unit 12 (step S124). Then, this sequence is ended.

Subsequently, an example of a flow of information processing executed by the image management system 10 is explained.

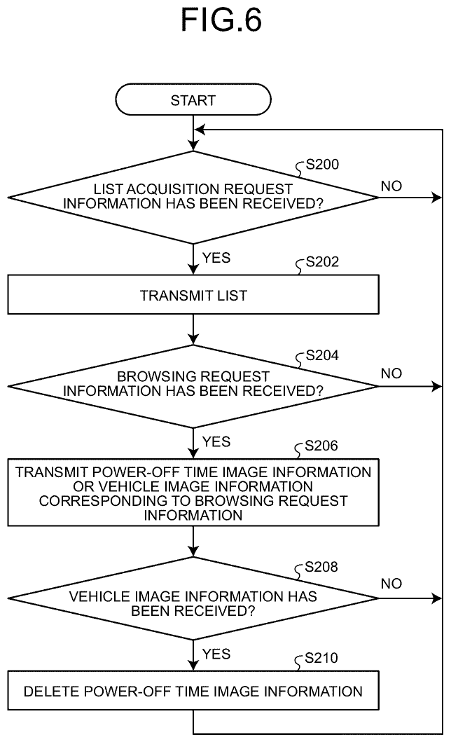

FIG. 6 is a flowchart illustrating an example of a flow of information processing executed by the image management system 10 of the present embodiment. FIG. 6 illustrates an example of processing executed in a state in which processing by the preprocessing unit 16A is executed and acquisition from the electronic device 20 and storage in the storage unit 12 of vehicle image information and power-off time image information are performed by the vehicle image information acquisition unit 16B and the storage control unit 16C.

The browsing request information acquisition unit 16D determines whether list acquisition request information has been received from the display terminal 50 (step S200). The browsing request information acquisition unit 16D repeats affirmative determination (step S200: Yes) and negative determination (step S200: No) in step S200. When the affirmative determination is made in step S200 (step S200: Yes), the processing proceeds to step S202.

The browsing request information acquisition unit 16D identifies an electronic device ID corresponding to a terminal ID included in the list acquisition request information acquired in step S110 in the user management information 12A. Then, the browsing request information acquisition unit 16D reads, as a list, the date and time and the attribute of each of all the vehicle image information and the power-off time image information stored in each of the event attribute storage areas E2 included in the electronic device storage area E1 to which the identified electronic device ID is assigned. The browsing request information acquisition unit 16D of the image management system 10 transmits the read list to the display terminal 50 (step S202).

Subsequently, the browsing request information acquisition unit 16D determines whether browsing request information representing a browsing request for power-off time image information has been received from the display terminal 50 (step S204). When making negative determination in step S204 (step S204: No), the browsing request information acquisition unit 16D returns to step S200 explained above. When affirmative determination is made in step S204 (step S204: Yes), the processing proceeds to step S206.

The transmission control unit 16E identifies, from the storage unit 12, power-off time image information corresponding to the electronic device ID corresponding to the terminal ID, the attribute of the power-off, and the date and time included in the browsing request information acquired in step S116. Then, the transmission control unit 16E transmits the identified power-off time image information and the date and time of the power-off time image information to the display terminal 50 at a transmission source of the browsing request information in step S204 (step S206).

The vehicle image information acquisition unit 16B determines whether vehicle image information has been received (step S208). When negative determination is made in step S208 (step S208: No), the processing returns to step S200. When affirmative determination is made in step S208 (step S208: Yes), the processing proceeds to step S210. In step S210, the storage control unit 16C deletes the power-off time image information registered in the event attribute storage area E2 to which the attribute ID of the attribute “power-off” is assigned in the electronic device storage area E1 to which the electronic device ID of the electronic device 20 at a transmission source of the vehicle image information acquired in step S208 is assigned in the storage unit 12 (step S210). Then, the processing returns to step S200.

As explained above, the information providing method in the present embodiment is an information providing method in the image management system 10 that communicates with the electronic device 20 mounted on the vehicle B that records vehicle image information captured by the imaging unit 30, which is mounted on the vehicle B and captures the surroundings of the vehicle B, and the display terminal 50 of the user R and manages the vehicle image information. In the information providing method according to the present embodiment, the vehicle image information is acquired from the electronic device 20. In the information providing method in the present embodiment, when browsing request information representing a browsing request for power-off time image information, which is vehicle image information from when power from the accessory power supply 40A to the electronic device 20 of the vehicle B is turned off up to the predetermined time t before, is acquired from the display terminal 50, the power-off time image information is transmitted to the display terminal 50 in order to cause the display terminal 50 display the power-off time image information.

In the related art, it is necessary to provide anew an imaging control unit that controls a start of storage of a captured image according to various parking operations of the vehicle B and a facility entrance detection unit that detects entrance of the vehicle B into a facility and it is difficult to easily provide information concerning a parking position with a simple configuration.

On the other hand, in the information providing method in the present embodiment, the power-off time image information acquired from the electronic device 20 mounted on the vehicle B is transmitted to the display terminal 50 in order to cause the display terminal 50 to display the power-off time image information. The power-off time image information is vehicle image information from when the power from the accessory power supply 40A to the electronic device 20 of the vehicle B is turned off up to the predetermined time t before. The accessory power supply 40A mounted on the vehicle B is a power supply that is switched from the on state to the off state when the user R parks the vehicle B in a desired place and operates the ignition switch or the like to the off state. For this reason, the power-off time image information indicates vehicle image information at the time when the vehicle B is parked. That is, the power-off time image information is vehicle image information including at least a period from the predetermined time t before the vehicle B is parked until the vehicle B is parked.

As explained above, in the information providing method in the present embodiment, the power-off from the accessory power supply 40A to the electronic device 20 is used as a trigger and the power-off time image information, which is the vehicle image information from when the power is turned off up to the predetermined time t before, is transmitted to the display terminal 50 in order to cause the display terminal 50 to display the power-off time image information. For this reason, the information providing method in the present embodiment can easily provide the power-off time image information, which is information concerning a parking position of the vehicle B, with a simple configuration without providing anew an imaging control unit that controls a start of storage of a captured image according to various parking operations of the vehicle B, a facility entrance detection unit that detects entrance of the vehicle B into a facility, and the like.

Therefore, the information providing method in the present embodiment can easily provide the information concerning the parking position with a simple configuration.

The electronic device 20 is a drive recorder that records vehicle image information captured by the imaging unit 30.

For this reason, by using the electronic device 20, which is the drive recorder mounted on the vehicle B, the information providing method in the present embodiment can provide the information concerning the parking position by adding or correcting software without adding new hardware.

### Second Embodiment

In the embodiment explained above, as an example, the mode is explained in which, when acquiring the browsing request information from the display terminal 50, the image management system 10 transmits the power-off time image information acquired from the electronic device 20 and stored in the storage unit 12 to the display terminal 50 in order to cause the display terminal 50 to display the power-off time image information.

In the present embodiment, a mode is explained in which, when acquiring browsing request information from the display terminal 50, an image management system 10B acquires power-off time image information from the electronic device 20 and transmits the power-off time image information to the display terminal 50 in order to cause the display terminal 50 to display the power-off time image information.

In the embodiment explained above, as an example, the mode is explained in which the predetermined time t in the power-off time image information, which is the vehicle image information from when the power is turned off up to the predetermined time t before, is the preset fixed period.

In the present embodiment, as an example, a mode is explained in which the predetermined time t in the power-off time image information can be changed according to an operation instruction to the display terminal 50 by the user R.

Note that, in the present embodiment, portions representing the same configurations and the same elements as those in the embodiment explained above are denoted by the same reference numerals and signs and detailed explanation of the portions is omitted.

FIG. 1 is a schematic diagram of an example of an information providing system 1B in the present embodiment. The information providing system 1B is the same as the information providing system 1 in the embodiment explained above except that the information providing system 1B includes an image management system 10B instead of the image management system 10.

FIG. 2 is a functional block diagram of an example of the information providing system 1B.

The electronic device 20 and the display terminal 50 are the same those in the embodiment explained above.

In the present embodiment, the processing unit 20D of the electronic device 20 stores vehicle image information acquired from the imaging unit 30 in the storage unit 20B as in the embodiment explained above. As in the embodiment explained above, every time an event having an attribute of impact detection occurs, the processing unit 20D stores a date and time of the event occurrence and the attribute of the occurred event in the storage unit 20B in association with the vehicle image information. Every time the event having the attribute of the impact detection occurs, the processing unit 20D transmits the date and time of the event occurrence, the attribute of the event, and the vehicle image information at the event occurrence time to the image management system 10B via the communication unit 20A.

As in the embodiment explained above, when the power from the accessory power supply 40A to the electronic device 20 is turned off, the processing unit 20D stores, in the storage unit 20B, an attribute representing the power-off, a date and time of the power-off, and power-off time image information, which is vehicle image information from when the power is turned off up to the predetermined time t before, in association with each other. However, the processing unit 20D in the present embodiment does not transmit the power-off time image information to the image management system 10B when the power is turned off. When receiving acquisition request information for the power-off time image information from the image management system 10B, the processing unit 20D in the present embodiment transmits, to the image management system 10B, the date and time of the power-off, the attribute representing the power-off, and the power-off time image information, which is the vehicle image information from when the power is turned off up to the predetermined time t before.

Subsequently, a functional configuration of the image management system 10B is explained.

The image management system 10B includes the storage unit 12, the communication unit 14, and a processing unit 17. The storage unit 12, the communication unit 14, and the processing unit 17 are communicably connected. The image management system 10B is the same as the image management system 10 in the embodiment explained above except that the image management system 10B includes the processing unit 17 instead of the processing unit 16.

The processing unit 17 executes various kinds of information processing in the image management system 10B. The processing unit 17 includes the preprocessing unit 16A, a vehicle image information acquisition unit 17B, the storage control unit 16C, the browsing request information acquisition unit 16D, and a transmission control unit 17E. The processing unit 17 is the same as the processing unit 16 in the embodiment explained above except that the processing unit 17 includes the vehicle image information acquisition unit 17B and the transmission control unit 17E instead of the vehicle image information acquisition unit 16B and the transmission control unit 16E.

Like the vehicle image information acquisition unit 16B, the vehicle image information acquisition unit 17B acquires vehicle image information from the electronic device 20.

As explained above, every time an event having an attribute of impact detection or the like occurs, the processing unit 20D of the electronic device 20 transmits a date and time of the event occurrence, the attribute of the event, and vehicle image information at the event occurrence time to the image management system 10B via the communication unit 20A. For this reason, every time the event of the impact detection or the like occurs, the vehicle image information acquisition unit 17B acquires the date and time of the event occurrence, the attribute of the event, and the vehicle image information at the event occurrence time.

Further, in the present embodiment, when the browsing request information acquisition unit 16D acquires browsing request information for power-off time image information from the display terminal 50, the vehicle image information acquisition unit 17B acquires the power-off time image information from the electronic device 20. That is, in the present embodiment, the power-off time image information is acquired from the electronic device 20 when the browsing request information is acquired from the display terminal 50.

Specifically, as in the embodiment explained above, the browsing request information acquisition unit 16D acquires browsing request information representing a browsing request for the power-off time image information from the display terminal 50. When the browsing request information for the power-off time image information is acquired from the display terminal 50, the vehicle image information acquisition unit 17B identifies, from the user management information 12A, an electronic device ID corresponding to a terminal ID included in the browsing request information. Then, the vehicle image information acquisition unit 17B transmits acquisition request information for the power-off time image information including the preset predetermined time t, to the electronic device 20 identified with the identified electronic device ID.

The processing unit 20D of the electronic device 20 having received the acquisition request information for the power-off time image information transmits, to the image management system 10B, a date and time of power-off, an attribute representing the power-off, and the power-off time image information, which is vehicle image information from the power-off up to the predetermined time t before. The processing unit 20D in the present embodiment uses, as the predetermined time t, the predetermined time t included in the acquisition request of the power-off time image information.

The vehicle image information acquisition unit 17B of the image management system 10B receives, from the electronic device 20, the date and time of the power-off, the attribute representing the power-off, and the power-off time image information, which is the vehicle image information from the power-off up to the predetermined time t before, to acquire these kinds of information.

The storage control unit 16C is the same as the storage control unit 16C in the embodiment explained above except that the vehicle image information or the power-off time image information acquired by the vehicle image information acquisition unit 17B instead of the vehicle image information acquisition unit 16B is stored in the storage unit 12.

The transmission control unit 17E transmits the power-off time image information, which the vehicle image information acquisition unit 17B acquires from the electronic device 20 when the browsing request information acquisition unit 16D acquires the browsing request information from the display terminal 50, to the display terminal 50 in order to cause the display terminal 50 to display the power-off time image information. For example, the transmission control unit 17E transmits the power-off time image information and the date and time of the power-off time image information to the display terminal 50 identified with the terminal ID included in the browsing request information.

The processing unit 50D of the display terminal 50 having received the power-off time image information displays the received power-off time image information on the UI unit 50C. For this reason, on the UI unit 50C of the display terminal 50, for example, the display screen 60C including the power-off time image information illustrated in FIG. 4C is displayed.

The user R who has played back and visually recognized the power-off time image information displayed on the display screen 60C sometimes desires to change the predetermined time t for the power-off time image information, which is the vehicle image information from when the power is turned off up to the predetermined time t before. For example, although the predetermined time t of the power-off time image information displayed on the display screen 60C is 30 seconds, the user R sometimes desires to view the power-off time image information for a longer time or a shorter time. In this case, the user R operates the UI unit 50C to input a change request for the predetermined time t. The processing unit 50D of the display terminal 50 transmits, to the image management system 10B, change request information for the predetermined time t including a changed predetermined time t′ for which input has been accepted.

When acquiring the change request information for the predetermined time t from the display terminal 50, the vehicle image information acquisition unit 17B of the image management system 10B identifies, from the user management information 12A, an electronic device ID corresponding to the terminal ID included in the change request information. In addition, the vehicle image information acquisition unit 17B sets, as the predetermined time t, the changed predetermined time t′ included in the acquired change request information. Then, the vehicle image information acquisition unit 17B transmits, to the electronic device 20 identified with the identified electronic device ID, acquisition request information for power-off time image information, the changed predetermined time t′ being set as the predetermined time t in the acquisition request information.

The processing unit 20D of the electronic device 20 having received the acquisition request information for the power-off time image information, the changed predetermined time t′ is set as the predetermined time t in the acquisition request information, transmits, to the image management system 10B, date and time of power-off, an attribute representing the power-off, and power-off time image information, which is vehicle image information from when the power is turned off up to the changed predetermined time t′ before.

The vehicle image information acquisition unit 17B of the image management system 10B receives, from the electronic device 20, the date and time of the power-off, the attribute representing the power-off, and the power-off time image information, which is the vehicle image information from when the power is turned off up to the changed predetermined time t′ before, to acquire these kinds of information. According to these kinds of processing, the vehicle image information acquisition unit 17B acquires, from the electronic device 20, as the power-off time image information, vehicle image information from when the power is turned off up to the changed predetermined time t′ represented by the change request information before.

The transmission control unit 17E transmits power-off time image information, which is vehicle image information from when power is turned off up to the changed predetermined time t′ before, that the vehicle image information acquisition unit 17B acquired from the electronic device 20 when the browsing request information acquisition unit 16D acquires browsing request information from the display terminal 50, to the display terminal 50 in order to cause the display terminal 50 to display the power-off time image information. For example, the transmission control unit 17E transmits the power-off time image information and the date and time of the power-off time image information to the display terminal 50 identified with the terminal ID included in the browsing request information.

The processing unit 50D of the display terminal 50 having received the power-off time image information displays the received power-off time image information on the UI unit 50C. For this reason, the UI unit 50C of the display terminal 50 displays the power-off time image information, which is the vehicle image information from when the power is turned off up to the changed predetermined time t′ changed by the operation instruction to the UI unit 50C by the user R before. Thus, the user R can easily check the power-off time image information in any period of the predetermined time t.

Subsequently, an example of a flow of information processing executed by the information providing system 1B in the present embodiment is explained.

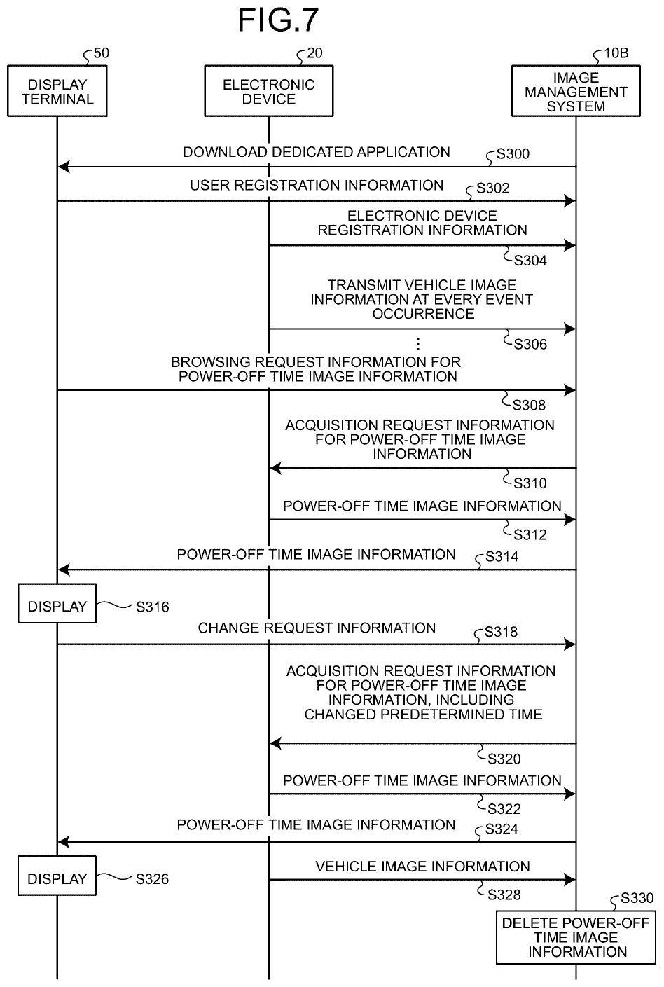

FIG. 7 is a sequence diagram illustrating the example of the flow of the information processing executed by the information providing system 1B in the present embodiment.

The processing unit 50D of the display terminal 50 transmits a dedicated application download request to the image management system 10B to download a dedicated application from the image management system 10B (step S300). The processing unit 50D of the display terminal 50 installs the downloaded dedicated application.

When user registration information is transmitted to the image management system 10B according to an operation instruction to the display terminal 50 by the user R (step S302), the preprocessing unit 16A of the image management system 10B receives the user registration information. The preprocessing unit 16A of the image management system 10B receives electronic device registration information including an electronic device ID of the electronic device 20 and at least one of a terminal ID and a user ID from the electronic device 20 (step S304). The preprocessing unit 16A registers the user ID, the terminal ID, and the electronic device ID received from the display terminal 50 and the electronic device 20 in user management information 12A in association with one another.

Every time an event having an attribute of impact detection or the like occurs, the processing unit 20D of the electronic device 20 transmits a date and time of the event occurrence, the attribute of the event, and vehicle image information at the event occurrence time to the image management system 10B (step S306). The storage control unit 16C of the image management system 10B stores the date and time of the event occurrence, the attribute of the event, and the vehicle image information at the event occurrence time acquired in step S306 in the storage unit 12 in association with one another.

When the vehicle B on which the electronic device 20 is mounted is parked and the electronic device 20 changes to a power-off state in which power supply from the accessory power supply 40A to the electronic device 20 is cut off, an attribute representing power-off, a date and time of the power-off, and power-off time image information, which is vehicle image information from when the power is turned off up to the predetermined time t before, is stored in the storage unit 12 of the electronic device 20. The storage unit 20B of the electronic device 20 stores vehicle image information captured by the imaging unit 30 in time series. For this reason, when the electronic device 20 changes to the power-off state in which the power supply from the accessory power supply 40A to the electronic device 20 is cut off, the processing unit 20D of the electronic device 20 assigns an attribute representing the power-off to vehicle image information captured at a date and time of the power-off among the vehicle image information in time series stored in the storage unit 20B. According to these kinds of processing, the processing unit 20D stores the attribute representing the power-off, the date and time of the power-off, and the power-off time image information, which is a part of the vehicle image information in time series stored in the storage unit 12.

After parking the vehicle B, the user R, who is a driver or the like of the vehicle B, operates the UI unit 50C of the display terminal 50 at desired timing to input a browsing request for the power-off time image information. The processing unit 50D of the display terminal 50 transmits, to the image management system 10B, browsing request information representing the browsing request for the power-off time image information (step S308).

When the browsing request information acquisition unit 16D of the image management system 10B acquires the browsing request information indicating the browsing request for the power-off time image information from the display terminal 50, the vehicle image information acquisition unit 17B of the image management system 10B identifies, from the user management information 12A, an electronic device ID corresponding to the terminal ID included in the browsing request information. Then, the vehicle image information acquisition unit 17B transmits acquisition request information for the power-off time image information including the preset predetermined time t, to the electronic device 20 identified with the identified electronic device ID (step S310).

The processing unit 20D of the electronic device 20 having received the acquisition request information for the power-off time image information transmits, to the image management system 10B, the date and time of the power-off, the attribute representing the power-off, and the power-off time image information, which is the vehicle image information from when the power is turned off up to the predetermined time t before (step S312). The processing unit 20D of the electronic device 20 uses, as the predetermined time t, the predetermined time t included in the acquisition request for the power-off time image information received from the image management system 10B.

The vehicle image information acquisition unit 17B of the image management system 10B receives, from the electronic device 20, the date and time of the power-off, the attribute representing the power-off, and the power-off time image information, which is the vehicle image information from when the power is turned off up to the predetermined time t before, to acquire these kinds of information.

The transmission control unit 17E of the image management system 10B transmits the power-off time image information acquired from the electronic device 20 in step S312 to the display terminal 50 in order to cause the display terminal 50 to display the power-off time image information (step S314). The processing unit 50D of the display terminal 50 having received the power-off time image information displays the received power-off time image information on the UI unit 50C (step S316). For this reason, on the UI unit 50C of the display terminal 50, for example, the display screen 60C including the power-off time image information illustrated in FIG. 4C is displayed.

For example, a scene is assumed in which the user R operates the UI unit 50C to input a change request for the predetermined time t by operating the UI unit 50C. In this case, the processing unit 50D of the display terminal 50 transmits, to the image management system 10B, change request information for the predetermined time t including the changed predetermined time t′ for which the input has been received (step S318).

The vehicle image information acquisition unit 17B of the image management system 10B identifies, from the user management information 12A, an electronic device ID corresponding to the terminal ID included in the change request information acquired in step S318. The vehicle image information acquisition unit 17B sets, as the predetermined time t, the changed predetermined time t′ included in the change request information acquired in step S318. Then, the vehicle image information acquisition unit 17B transmits, to the electronic device 20 identified with the identified electronic device ID, acquisition request information for the power-off time image information, the changed predetermined time t′ being set in the acquisition request information as the predetermined time t (step S320).

The processing unit 20D of the electronic device 20 having received the acquisition request information for the power-off time image information, the changed predetermined time t′ being set in the acquisition request information as the predetermined time t, transmits, to the image management system 10B, the date and time of the power-off, the attribute representing the power-off, and the power-off time image information, which is the vehicle image information from when the power is turned off up to the predetermined time t′ before the change (step S322).

The transmission control unit 17E of the image management system 10B transmits the power-off time image information, which is the vehicle image information from when the power is turned off up to the predetermined time t′ before, acquired from the electronic device 20 in step S322 to the display terminal 50 in order to cause the display terminal 50 to display the power-off time image information (step S324).

The processing unit 50D of the display terminal 50 having received the power-off time image information displays the received power-off time image information on the UI unit 50C (step S326). For this reason, the UI unit 50C of the display terminal 50 displays the power-off time image information, which is the vehicle image information from when the power is turned off up to the changed predetermined time t′ changed by the operation instruction to the UI unit 50C by the user R before. Thus, the user R can easily check the power-off time image information in any period of the predetermined time t. Then, this sequence is ended.

Subsequently, an example of a flow of information processing executed by the image management system 10B is explained.

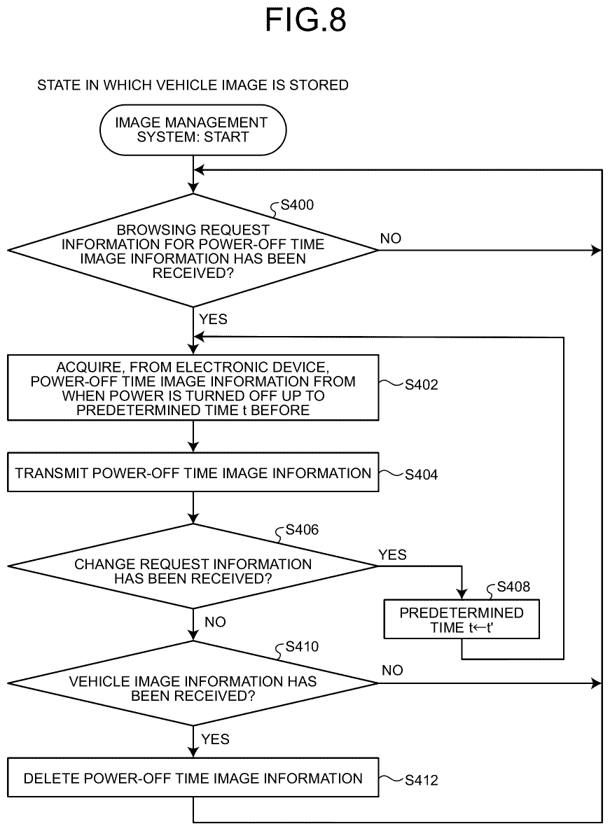

FIG. 8 is a flowchart illustrating an example of a flow of information processing executed by the image management system 10B in the present embodiment. FIG. 8 illustrates an example of processing executed in a state in which processing by the preprocessing unit 16A is executed and acquisition of vehicle image information and storage of the vehicle image information in the storage unit 12 are performed by the vehicle image information acquisition unit 17B and the storage control unit 16C.

The browsing request information acquisition unit 16D of the image management system 10B determines whether browsing request information indicating a browsing request for power-off time image information has been received from the display terminal 50 (step S400). The browsing request information acquisition unit 16D repeats negative determination (step S400: No) until affirmative determination (step S400: Yes) is made in step S400. When the affirmative determination is made in step S400 (step S400: Yes), the processing proceeds to step S402.

In step S402, the vehicle image information acquisition unit 17B acquires power-off time image information, which is vehicle image information from when the power is turned off up to the predetermined time t before, from the electronic device 20 (step S402). Specifically, the vehicle image information acquisition unit 17B identifies, from the user management information 12A, an electronic device ID corresponding to a terminal ID included in the browsing request information received in step S400. Then, the vehicle image information acquisition unit 17B transmits acquisition request information for the power-off time image information including the preset predetermined time t, to the electronic device 20 identified with the identified electronic device ID. Then, as a reply to the acquisition request information, the vehicle image information acquisition unit 17B receives, from the electronic device 20, date and time of the power-off, an attribute representing the power-off, and power-off time image information, which is vehicle image information from the power-off up to the predetermined time t before. By receiving these pieces of information, a browsing request information acquisition unit 17D acquires the power-off time image information from the electronic device 20.

The transmission control unit 17E of the image management system 10B transmits the power-off time image information acquired from the electronic device 20 in step S402 to the display terminal 50 in order to cause the display terminal 50 to display the power-off time image information (step S404). The processing unit 50D of the display terminal 50 having received the power-off time image information displays the received power-off time image information on the UI unit 50C. For this reason, on the UI unit 50C of the display terminal 50, for example, the display screen 60C including the power-off time image information illustrated in FIG. 4C is displayed.

Subsequently, the vehicle image information acquisition unit 17B of the image management system 10B determines whether change request information for the predetermined time t has been received from the display terminal 50 (step S406). When affirmative determination is made in step S406 (step S406: Yes), the processing proceeds to step S408. In step S408, the vehicle image information acquisition unit 17B sets, as the predetermined time t, the changed predetermined time t′ included in the change request information acquired in step S406 (step S408). Then, the processing proceeds to step S402 explained above.

When negative determination is made in step S406 (step S406: No), the processing proceeds to step S410. In step S410, the vehicle image information acquisition unit 17B determines whether vehicle image information has been received (step S410). When negative determination is made in step S410 (step S410: No), the processing returns to step S400 explained above. When affirmative determination is made in step S410 (step S410: Yes), the processing proceeds to step S412. In step S412, the storage control unit 16C deletes the power-off time image information registered in the event attribute storage area E2 to which an attribute ID of an attribute “power off” is assigned in the electronic device storage area E1 to which the electronic device ID of the electronic device 20 at a transmission source of the vehicle image information acquired in step S410 is assigned in the storage unit 12 (step S412). Then, the processing returns to step S400.

As explained above, in the information providing method in the present embodiment, when the browsing request information is acquired from the display terminal 50, the power-off time image information is acquired from the electronic device 20 and the acquired power-off time image information is transmitted to the display terminal 50 in order to cause the display terminal 50 to display the power-off time image information.

For this reason, the information providing method in the present embodiment can easily provide information concerning a parking position with a simple configuration as in the embodiment explained above.

Subsequently, a hardware configuration of the processing unit explained in the embodiments explained above is explained.

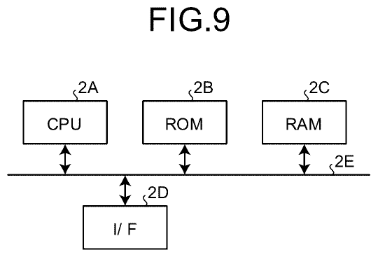

FIG. 9 is a block diagram illustrating a hardware configuration example of the processing unit 16, the processing unit 17, the processing unit 50D, and the processing unit 20D explained in the embodiments explained above.

The processing unit 16, the processing unit 17, the processing unit 50D, and the processing unit 20D explained in the embodiments explained above include a control device such as a CPU (Central Processing Unit) 2A, a storage device such as a ROM (Read Only Memory) 2B or a RAM (Random Access Memory) 2C, an I/F 2D that is connected to a network and performs communication, and a bus 2E that connects the units.

Programs executed by the processing unit 16, the processing unit 17, the processing unit 50D, and the processing unit 20D explained in the embodiments explained above are provided by being incorporated in the ROM 2B or the like in advance.

The programs executed by the processing unit 16, the processing unit 17, the processing unit 50D, and the processing unit 20D explained in the embodiments explained above may be provided as a computer program product by being recorded as a file in an installable format or an executable format in a computer-readable recording medium such as a CD-ROM (Compact Disk Read Only Memory), a flexible disk (FD), a CD-R (Compact Disk Recordable), or a DVD (Digital Versatile Disk).

Further, the programs executed by the processing unit 16, the processing unit 17, the processing unit 50D, and the processing unit 20D explained in the embodiments explained above may be stored on a computer connected to a network such as the Internet and provided by being downloaded through the network. The programs executed by the processing unit 16, the processing unit 17, the processing unit 50D, and the processing unit 20D explained in the embodiments explained above may be provided or distributed via a network such as the Internet.

The programs executed by the processing unit 16, the processing unit 17, the processing unit 50D, and the processing unit 20D explained in the embodiments explained above can cause a computer to function as the processing unit 16, the processing unit 17, the processing unit 50D, and the processing unit 20D explained in the embodiments explained above. In this computer, the CPU 2A can read a program from a computer-readable storage medium onto a main storage device and execute the program.

According to the information providing method, the information display method, and the computer-readable medium according to the present disclosure, it is possible to easily provide the information concerning the parking position with a simple configuration.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information providing method in an image management system that communicates with an electronic device and a display terminal of a user, and manages vehicle image information captured by an imaging unit mounted on a vehicle to image surroundings of the vehicle, the electronic device being mounted on the vehicle and recording the vehicle image information, the information providing method comprising:
acquiring the vehicle image information from the electronic device; and
transmitting power-off time image information to the display terminal to cause the display terminal to display the power-off time image information when acquiring, from the display terminal, browsing request information representing a browsing request for the power-off time image information, the power-off time image information being the vehicle image information from when power from an accessory power supply of the vehicle to the electronic device is turned off up to a predetermined time before.

2. The information providing method according to claim 1, wherein
the power-off time image information is acquired when the power from the accessory power supply of the vehicle to the electronic device is turned off, and
the power-off time image information designated in the browsing request information from the display terminal is transmitted to the display terminal to cause the display terminal to display the power-off time image information.

3. The information providing method according to claim 1, wherein
the power-off time image information is acquired from the electronic device when the browsing request information is acquired from the display terminal, and
when the browsing request information is acquired from the display terminal, the power-off time image information is acquired from the electronic device and the acquired power-off time image information is transmitted to the display terminal to cause the display terminal to display the power-off time image information.

4. The information providing method according to claim 3, wherein
when change request information for the predetermined time is acquired from the display terminal, the vehicle image information from when the power is turned off up to the changed predetermined time represented by the change request information before is acquired from the electronic device as the power-off time image information.

5. The information providing method according to claim 1, wherein
the electronic device is a drive recorder.

6. An information display method in a display terminal of a user that communicates with an image management system that acquires vehicle image information from an electronic device, and manages the vehicle image information, the vehicle image information being captured by an imaging unit mounted on a vehicle to image surroundings of the vehicle, the electronic device being mounted on the vehicle to record the vehicle image information, the information display method comprising:
transmitting, to the image management system, browsing request information representing a browsing request for power-off time image information, which is the vehicle image information from when power from an accessory power supply of the vehicle to the electronic device is turned off up to a predetermined time before; and
displaying the power-off time image information received from the image management system.

7. A non-transitory computer readable medium on which programmed instructions are stored, wherein the programmed instructions, when executed by a computer of an image management system that communicates with an electronic device and a display terminal of a user, and manages vehicle image information captured by an imaging unit mounted on a vehicle to image surroundings of the vehicle, the electronic device being mounted on the vehicle and recording the vehicle image information, cause the computer to perform:
acquiring the vehicle image information from the electronic device; and
transmitting power-off time image information to the display terminal to cause the display terminal to display the power-off time image information when acquiring, from the display terminal, browsing request information representing a browsing request for the power-off time image information, the power-off time image information being the vehicle image information from when power from an accessory power supply of the vehicle to the electronic device is turned off up to a predetermined time before.
